(19) United States
(12) Patent Application Publication
(10) Pub. No.: US 2015/0182895 A1
(43) Pub. Date: Jul. 2, 2015

(54) PROCESS FOR MAKING RIGID POROUS PLASTIC TUBULAR FILTERS

(71) Applicant: BHA Altair, LLC, Franklin, TN (US)

(72) Inventors: Vishal Bansal, Overland Park, KS (US); Bryan David Yetter, Kearney, MO (US)

(21) Appl. No.: 14/144,723

(22) Filed: Dec. 31, 2013

(51) Int. Cl. B01D 46/00; B29C 41/50; B29C 41/02

(52) U.S. Cl. CPC B01D 46/0001; B29C 41/02; B29C 41/50

(57) ABSTRACT

A method of making a rigid filter. An elongate mandrel is provided. A polymer material is melted. The polymer material is formed into a molten fiber. The molten fiber is moved to the mandrel. Successive layers of fibers are accumulated about the mandrel and along the elongation of the mandrel to form a fiber accumulation. The fiber accumulation has pores extending between the fibers and having an exterior and a hollow interior. The fiber accumulation is solidified so that the fiber accumulation is rigid with the pores, the exterior and the hollow interior being present such that fluid can proceed between the exterior and the hollow interior through the pores and particulate is blocked by the fiber accumulation.

### FIELD OF THE INVENTION

The present invention relates generally to a filter. In particular, the present invention relates to a filter having improved construction and function.

### BACKGROUND OF THE INVENTION

There is increasing environmental regulatory control throughout the world. Much of the regulatory control is focused on reducing air-borne pollutants and emissions from certain industrial sources, such as power plants and materials production facilities. A known technique to control the pollutants and emissions from the industrial sources is to separate undesirable particulate matter that is carried in a gas stream by fabric filtration. Such fabric filtration is accomplished in a dust collection apparatus known in the industry as a “baghouse.”

The baghouse typically includes a housing divided into two plenums by a tube sheet. One plenum is a “dirty air” plenum which communicates with an inlet and receives “dirty” or particulate laden gas from a source at the plant. The other plenum is a “clean air” plenum which receives cleaned gas after filtration and communicates with an outlet to direct cleaned gas away from the baghouse. A plurality of relatively long cylindrical fabric filters, commonly called “bags,” are suspended from the tube sheet in the dirty air plenum. Each bag has a closed lower end and is installed over a cage. Each bag is mounted to the tube sheet at its upper end and hangs vertically downward into the dirty air plenum. The upper end portion of the bag is open and the interior of each bag is in fluid communication with the clean air plenum.

In operation, particulate laden gas is conducted into the dirty air plenum. As the particulate laden gas flows through the baghouse, the particulates carried by the gas engage the exterior of the fabric filter bags and accumulate on or in media of the fabric filter bags or are separated from the gas stream and fall into an accumulator chamber at the lower portion of the dirty air plenum. Cleaned gas then flows through the media of the fabric filter bags, into the interior of the fabric filter bags, to the clean air plenum and through the outlet. Although many baghouses are made according to this basic structure, there may be numerous operational and structural differences among baghouses.

There is interest in replacing known fabric filter bags. Some possible benefits to fabric bag replacement include improvements in filtering efficiencies, improvements in cost, and improvements in durability.

A melt-blown process is known in the art for manufacturing soft and drapeable barrier fabrics in sheet-like form. Such sheets of fabrics can be used in filtration applications. However, if such sheets of melt-blown fabrics were to be considered for use to create fabric filter bags, the sheets would need to be stitched, stapled or otherwise fastened so as to provide a “bag” shape. Working to provide such a bag shape could have some impediments, additional steps or the like that may provide for inefficiencies in a manufacturing process. Accordingly, there is a continued need in the industry for improvements.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some aspects of the invention in a simplified form as a prelude to the more detailed description that is presented later.

In accordance with one aspect, the present invention provides a method of making a rigid filter. An elongate mandrel is provided. A polymer material is melted. The polymer material is formed into a molten fiber. The molten fiber is moved to the mandrel. Successive layers of fibers are accumulated about the mandrel and along the elongation of the mandrel to form a fiber accumulation. The fiber accumulation has pores extending between the fibers and having an exterior and a hollow interior. The fiber accumulation is solidified so that the fiber accumulation is rigid with the pores, the exterior and the hollow interior being present such that fluid can proceed between the exterior and the hollow interior through the pores and particulate is blocked by the fiber accumulation.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an arrangement performing a method for making a rigid filter in accordance with an aspect of the present invention;

FIG. 2 is schematic view of an example filter on a mandrel of the arrangement of FIG. 1, with the filter having been made by the method in accordance with an aspect of the invention;

FIG. 3 is a schematic end view of an example mandrel in a first condition during the process of making a filter in accordance with an aspect of the invention;

FIG. 4 is a view similar to FIG. 5, but with the mandrel in a second condition to permit filter removal subsequent to the process of making in accordance with an aspect of the invention;

FIG. 5 is a schematic end view of another example mandrel having apertures in accordance with an aspect of the invention;

FIG. 6 is a schematic view similar to FIG. 2, but with the mandrel of the arrangement being a portion of the filter in accordance with an aspect of the invention;

FIG. 7 is an example of another filter that can be made via a process in accordance with an aspect of the present invention;

FIG. 8 is a schematic view of an example heat treating oven for heat treating a filter in accordance with an aspect of the invention;

FIG. 9 is a schematic view of an example chemical treatment unit for chemically treating a filter in accordance with an aspect of the invention

FIG. 10 is a schematic illustration showing an example processing step used to make a filter in accordance with an aspect of the present invention;

FIG. 11 is a schematic illustration of a filter having potted end caps in accordance with an aspect of the present invention; and

FIG. 12 is a schematic illustration of an example filter house within which example filters, in accordance with an aspect of the present invention, are utilized.

### DESCRIPTION OF EXAMPLE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

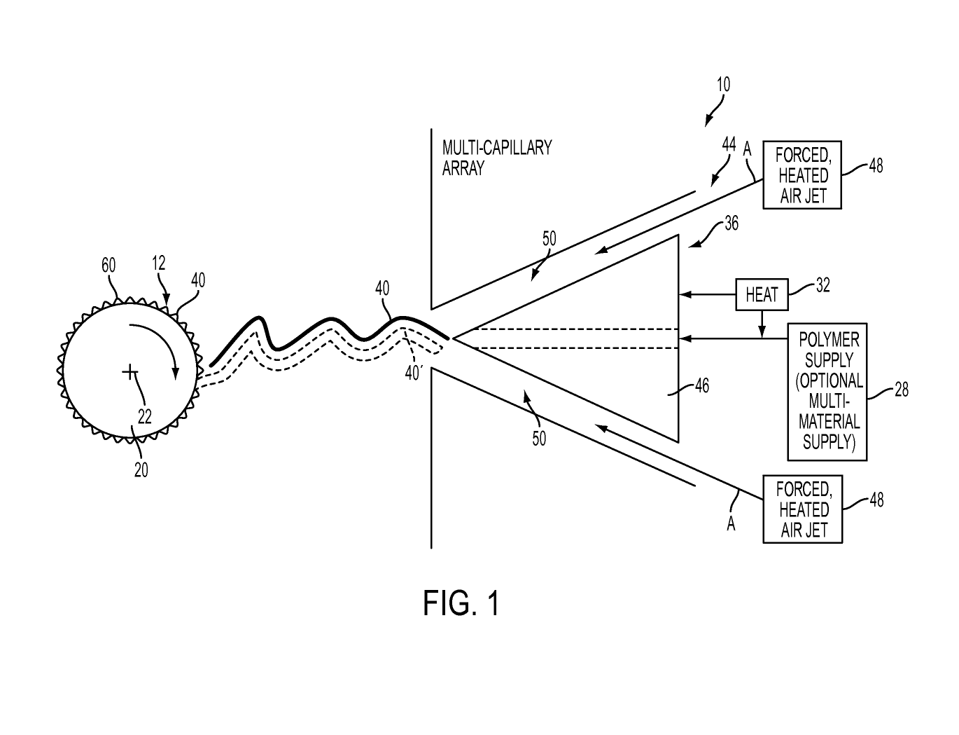

An example arrangement 10 for performing a method of making a filter 12, in accordance with an aspect of the present invention, is schematically shown within FIG. 1. The arrangement 10 includes an elongate mandrel 20. Within the shown example, the mandrel 20 is a rotatable about an axis 22. However, it is contemplated that the mandrel 20 may be stationary while other portions of the arrangement 10 move relative thereto. Dependent upon which portion of the arrangement 10 is relatively moving, appropriate motive force portion(s) (not shown within FIG. 1) are provided. Also with the shown example, the mandrel 20 is cylindrical. However, it is contemplated that the mandrel 20 may have a different shape (e.g., ovoid, star, triangle, or pleated in cross-section).

The arrangement 10 includes a supply 28 of at least one polymer material. Within one specific example, multiple polymer materials may be supplied. Some examples of supplied polymer material(s) include polyethylene, ultra-high-molecular-weight polyethylene (UHMWPE), polybutylene terephthalate (PBT), polytetrafluoroethylene (PTFE), polyvinylidene difluoride (PVDF), polyester, polypropylene, nylon, or polyphenylene sulfide (PPS). It is to be appreciated that other materials could be provided/used.

The arrangement 10 includes at least one heater 32 to heat and melt the polymer material. Also, the arrangement 10 includes at least one mechanism 36 to form (e.g., draw) the polymer material as at least one molten fiber 40. Within one specific example, the forming (e.g., drawing) of the polymer material as at least one molten fiber includes forming (e.g., drawing) multiple molten fibers (e.g., 40, 40′). For example there may be provided an array (i.e., a plurality) of mechanisms 36 to form (e.g., draw) the polymer material(s) as a plurality of molten fibers (e.g., 40, 40′). The array may be linearly spaced along the axis 22 of the mandrel 20, circumferentially about the mandrel, or both. FIG. 1 shows one of such plurality of molten fibers 40 in solid line and a second of such plurality of molten fibers 40′ in dash line. As is indicated within FIG. 1, the array (i.e., a plurality) of mechanisms 36 is represented by the legend of “ARRAY.” It is contemplated that the plurality of molten fibers (e.g., 40, 40′) may be similar/identical or may be different. The difference(s) may include differences in material and/or thickness. Such could be considered as providing a filter 12 that is bi-component, tri-component, etc. Herein, the fibers (e.g., 40, 40′) may be referred to generically or collectively via the single reference numeral 40.

Also, it is contemplated that some higher melting point staple fibers could also be provided and entrained along with the melt blown fibers. In one example, the higher melting point staple fibers could have a softening temperature at least 30° C. higher than the melting point of polymer material of the molten fibers. The higher melting point staple fibers could be organic or inorganic. Some example materials for the higher melting point staple fibers include PVDF, PTFE, fiberglass, carbon, aramids, polysulfone, or metals. The section may be based upon the section of the material of the molten fibers. These higher melting point fibers assist in obtaining a filter with higher air permeability and porosity. For such an example, the fibers (e.g., 40, 40′) generically or collectively refer to all of the fibers within the filter 12.

Associated with the one or more mechanisms 36 to form (e.g., draw) the polymer material as molten fiber(s) 40 is one or more mechanisms 44 to move the molten fiber(s) 40 to the mandrel 20. Within the shown example of FIG. 1, there is a mechanism 44 to move the molten fiber 40 to the mandrel for each mechanism 36 to form (e.g., draw) the polymer material as a molten fiber.

It is to be appreciated that the specifics of each mechanism 36 to form (e.g., draw) the polymer material as a molten fiber 40 and mechanism 44 to move the molten fiber to the mandrel 20 can be varied. Within the shown example of FIG. 1, the molten polymer material is provided to a capillary action feed member 46. Adjacent to the feed member 46 is at least one forced, heated air jet 48. Specifically, within the shown example, two forced, heated air jets 48 are provided. The forced, heated air jets 48 move heated air A along pathways 50 adjacent to the capillary action feed member 46 such that the molten polymer material is pulled/forced from the capillary action feed member as a molten fiber 40. The pulling/forcing can be capillary action, venturi action and/or other actions.

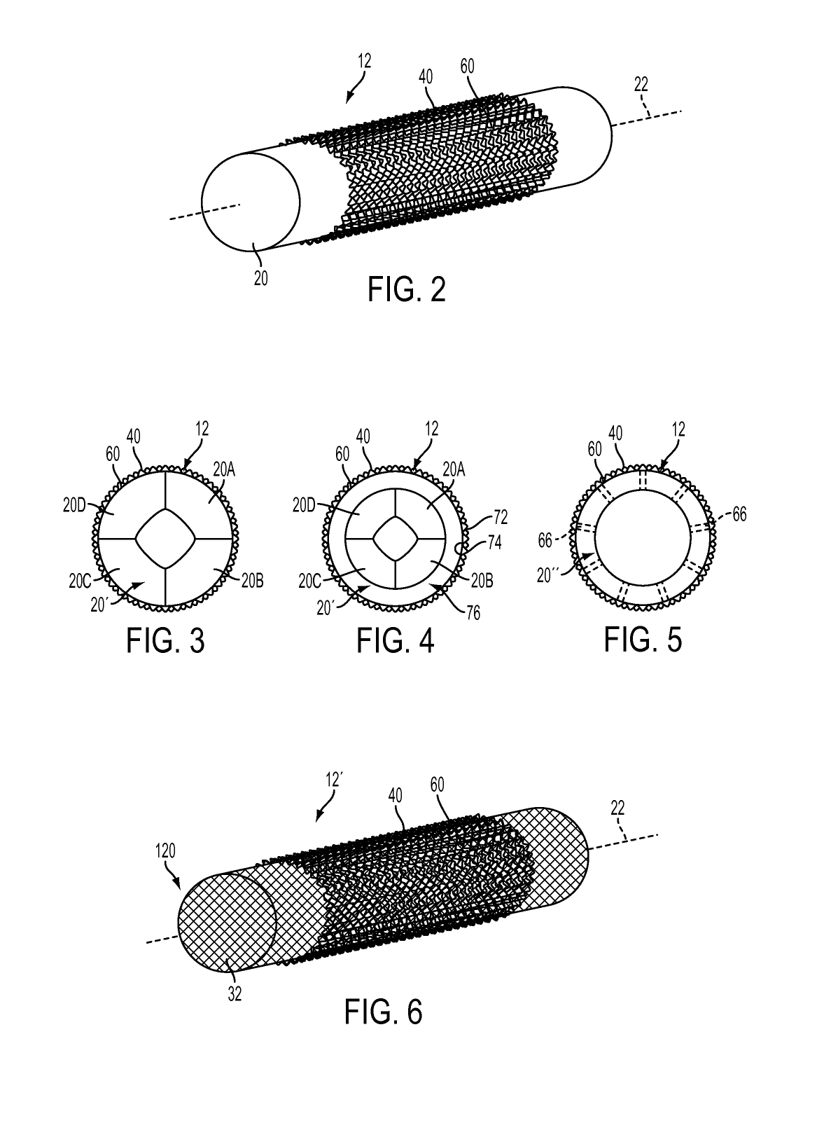

As the molten fiber(s) 40 are moved to the mandrel 20, there is relative movement. As mentioned, the mandrel 20 could be rotated. Also as mentioned, other portions could be moved relative to the mandrel 20. As the movement occurs, the molten fiber(s) 40 are accumulated on the mandrel 20. See FIG. 2. The accumulation is an accumulation of successive layers of fibers 40 about the mandrel 20. Also, the accumulation is along the elongation of the mandrel 20 (i.e., along the axis 22) as a cylindrical tube.

The molten fibers 40 can adhere (i.e., stick) to each other due to the molten state. Once the fibers 40 solidify, the adhesion is permanent. Also, the fibers 40 become increasingly rigid during solidification and as such also retain their position relative to other fibers. Eventually, all of the fibers 40 accumulated on the mandrel 20 solidify, to become a rigid member (i.e., the filter 12).

The accumulated successive layers of fibers 40 having pores 60 extending there between. As such, there is porosity. With the fiber accumulation solidified and the pores 60 present, the accumulation is usable for the function of filtration by the filter 12. The fiber accumulation is removed from the mandrel 20 for use as the filter 12. Removal of the fiber accumulation from the mandrel 20 can be accomplished in a variety of processes and via a variety of mechanisms. FIGS. 3 and 4 schematically show one type of process/mechanism for fiber accumulation removal. Specifically, FIG. 3 shows a mandrel 20′ with four radially movable quadrants 20A-20D. During accumulation of the fibers 40, the four radially movable quadrants 20A-20D are in the radially outward position as shown within FIG. 3. Subsequent to accumulation and solidifying, the four radially movable quadrants 20A-20D are moved radially inward as shown within FIG. 4 (e.g., as a collapsible mandrel). Thus, the fiber accumulation is released from the mandrel 20′ for removal. Also, the mandrel 20 could have additional/different features. For example, FIG. 5 shows a mandrel 20″ that includes bores 66 through which a vacuum could be applied to help draw the molten fibers 40 onto the mandrel 20″ and/or cool/solidify the molten fibers.

It is to be appreciated that in view of the porosity of the filter 12 (i.e., the fiber accumulation), fluid (e.g., air) can flow through the filter. However, dependent upon porosity, pore size, etc., at least some particulate matter that is entrained within the fluid is blocked (i.e., filtered out) from the fluid as the fluid flows through the filter 12. It is to be appreciated that the type, amount, etc., of the particulate that is filtered out can be related to the porosity, pore size, etc. of the filter 12.

It is to be appreciated that it is the flow of fluid through the filter 12 is associated with the filtering action. As such, there is a flow from one (e.g., a first) side 72 (see FIG. 4) to another (e.g., a second) side 74 of the filter 12. In some respects, the first side 72 of the filter 12 can be considered to be a “dirty” side and the second side 74 can be considered to be a clean side. Also, the two sides 72, 74 can be defined/dependent upon the shape/configuration of the filter 12, and/or the flow direction of the fluid. Within the shown examples in FIGS. 1-5, the shape of the filter 12 is a tubular cylinder (e.g., tube) that extends about and along the axis 22, with the first side 72 being an outer cylindrical surface (i.e., faces outward away from axis 22) and the second side 74 being an inner cylindrical surface (i.e., faces inward toward axis 22). Thus, fluid flow can be radially inward to a hollow interior 76 (again see FIG. 4) of the cylinder shape of the filter 12. Of course, it is to be appreciated that other shapes/configurations are contemplated.

As discussed, it is to be appreciated that the accumulation of fibers 40, itself, can be the filter 12. Also, it is to be appreciated that the mandrel can become part of the filter. Such results in a possible benefit of not needing to remove the fiber accumulation from the mandrel. Also such results in a possible benefit of the mandrel providing some additional feature (e.g., additional strength). FIG. 6 shows one example in which the mandrel 120 is formed as a screen or other porous member (e.g., a perforate cylinder). The mandrel 120 can be made of metal wire mesh screen, plastic or other material having a desired property. The fibers 40 providing the fiber accumulation are not removed from the mandrel and as such the mandrel 120 is part of the filter 12′. The filter 12′ still has pores 60, and still has first and second sides. In some respects, the first side of the filter 12′ can be considered to be a “dirty” side and the second side can be considered to be a clean side. Also, the two sides can be defined/dependent upon the shape/configuration of the filter 12′, and/or the flow direction of the fluid. With the shape of the filter 12 being a cylinder that extends about and along an axis 22, with the first side being an outer cylindrical surface (i.e., faces outward away from axis 22) and the second side being an inner cylindrical surface (i.e., faces inward toward axis 22). Thus, fluid flow can be radially inward to a hollow interior 76 of the cylinder shape of the filter 12′. It is to be appreciated that although the filter 12′ is identified with the use of “′” (prime) to designate at least some difference (e.g., mandrel 120 in place), the use of the simple numeric designator without the “′” (e.g., simply 12) can be generically collectively used for reference of all filters including the filter with the mandrel 120 in remaining place.

At this point it is worth noting that one aspect of the present invention is thus a method of making a rigid filter. The method includes providing an elongate mandrel. A polymer material is melted. The polymer material is formed into a molten fiber. The molten fiber is moved to the mandrel. Successive layers of fibers are accumulated about the mandrel and along the elongation of the mandrel to form a fiber accumulation. The fiber accumulation has pores extending between the fibers and has an exterior and a hollow interior. The fiber accumulation is solidified so that the fiber accumulation is rigid with the pores, the exterior and the hollow interior present such that fluid can proceed between the exterior and the hollow interior through the pores and particulate is blocked by the fiber accumulation.

As mentioned, it is to be appreciated that in view of the porosity of the filter 12, fluid (e.g., air) can flow through the filter. However, it is contemplated that porosity, pore size, etc. can be varied via various parameters, such as fiber type, fiber diameter, tightness of accumulation, thickness of accumulation, use of multiple materials, multiple layers, etc. As such it is to be appreciated that, dependent upon porosity, pore size, etc., at least some particulate matter that is entrained within the fluid is blocked (i.e., filtered out) from the fluid as the fluid flows through the filter 12. It is to be appreciated that the type, amount, etc., of the particulate that is filtered out can be related to the porosity, pore size, etc. of the filter 12. Also, it is contemplated that various mixtures of fiber type, fiber diameter, tightness of accumulation, thickness of accumulation, use of multiple materials, multiple layers, shape, etc. can be used. In some examples, the selections can be done so as to optimize a desired balance of strength, ductility, filtration efficiency, air permeability, and dust release characteristics.

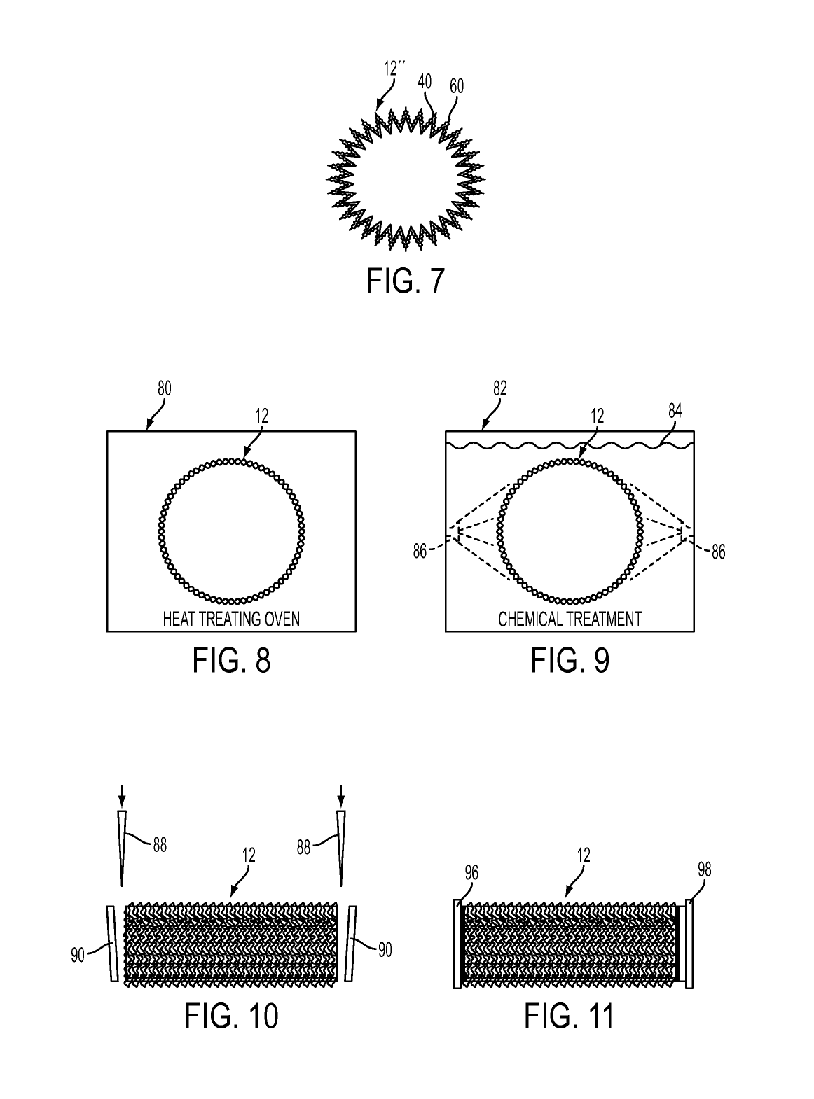

Turning to the construction of filter 12, as mentioned the filter could have a variety of shapes and the shapes are generally guided by the shape of the mandrel (e.g., 20, 120) upon which the molten fibers 40 are directed. As mentioned the mandrel 20 may have a variety of shapes (e.g., ovoid, star, triangle, or pleated in cross-section). As such the produced filter 12 may have a variety of shapes (e.g., ovoid, star, triangle, or pleated in cross-section). FIG. 7 shows a filter shape of a filter 12″ (again a generic/collective reference numeral 12 also covers such a filter) that has a pleated shape as just one example. It is to be appreciated that although the filter 12″ has a pleated shape, the pleats are not formed by folding but a formed as the molten fibers 40 are accumulated on a pleated-shape mandrel. Thus, in accordance with one aspect of the present invention, a pleated shape can be achieved within the need of a separate folding step.

It is to be appreciated that various other, additional or different processes or procedures could be utilized in the creation/processing of the filter 12. One example of additional or different process/procedure is schematically shown in FIG. 8. Specifically, a heat treating oven 80 is schematically shown. The oven 80 is utilized to apply heat to the filter 12 to heat treat the filter. The specifics (e.g., temperature, duration, cycling, etc.) of the heat treating can be varied and may be varied based upon material(s), filter size, filter thickness, fiber size, etc. Also, the specifics (e.g., temperature, duration, cycling, etc.) of the heat treating can be varied and may be varied to yield desired balance of strength, ductility, and porosity.

Another example of additional or different process/procedure is schematically shown in FIG. 9. Specifically, a chemical treatment structure 82 is shown. The chemical treatment structure 82 is utilized for the application of treating chemical to the filter 12. Within the shown example, the chemical treatment structure 82 shows a fluid level 84 to indicate that the chemical treatment structure 682 may be a vessel or tank, and that the chemical treatment may be via immersion within the fluid chemical. As an alternative to immersion within fluid chemical, spray nozzles 86, shown in phantom to indicate an alternative, may be provided for chemicals that are to be sprayed on for treatment. The specifics (e.g., particular chemical, duration of treatment, cycling, etc.) of the chemical treatment can be varied and may be varied based upon material(s), filter size, filter thickness, fiber size, etc. In one specific example, a surface oleophobic chemical treatment can be imparted to the filter 12.

Another example of additional or different process/procedure is schematically shown in FIG. 10. Specifically, physical shaping of the created filter 12 is presented within the example of FIG. 10. Within the example, cutting tools 88 are schematically shown which cut axial ends of the cylindrical shaped filter provided via the molding process. Within the schematic representation the arrowheads represent a cutting stroke of the cutting tools 78. The cutting removes portions 80 of the molded filter 12 from the remainder of the filter. The cutting can provide trimming to dimension to a specific axial length, and/or trimming to achieve a certain end profile/face. Of course, it is contemplated that various other processes/procedures can be performed upon the filter 12. For example, another process/procedure that can be performed upon the filter 12 is a machining operation to provide a smooth outer surface finish for better dust release in operation.

Once the various processes/procedures are performed upon the filter 12, various other steps can be performed with the filter. For example, FIG. 11 shown a filter 12 fitted with end plate(s) 96 and/or fitting(s) 98. Each end plate 96 may provide for blocking-off an otherwise open end of the filter 12. Each fitting 98 may provide for securing of the filter into a receiving member or housing. The fitting may include sealing member(s), securing member(s), or the like. Also, the fitting 98 may provide a through aperture that is aligned with the axis 22 of the filter 12 and thus provides an opening for fluid communication with the hollow interior 76 of the filter 12. Accordingly, fluid can flow through the filter 12. The fluid flow is blocked by the end plate 96, but is permitted to flow through the aperture of the fitting 98. The end plate(s) 96 and/or fitting(s) 98 may be secured to the filter 12 in any suitable manner, such as adhesive, potting, mechanical fastener. Also, the filter 12 may be otherwise configured to have closed and open ends (e.g. filter material may form the closed end).

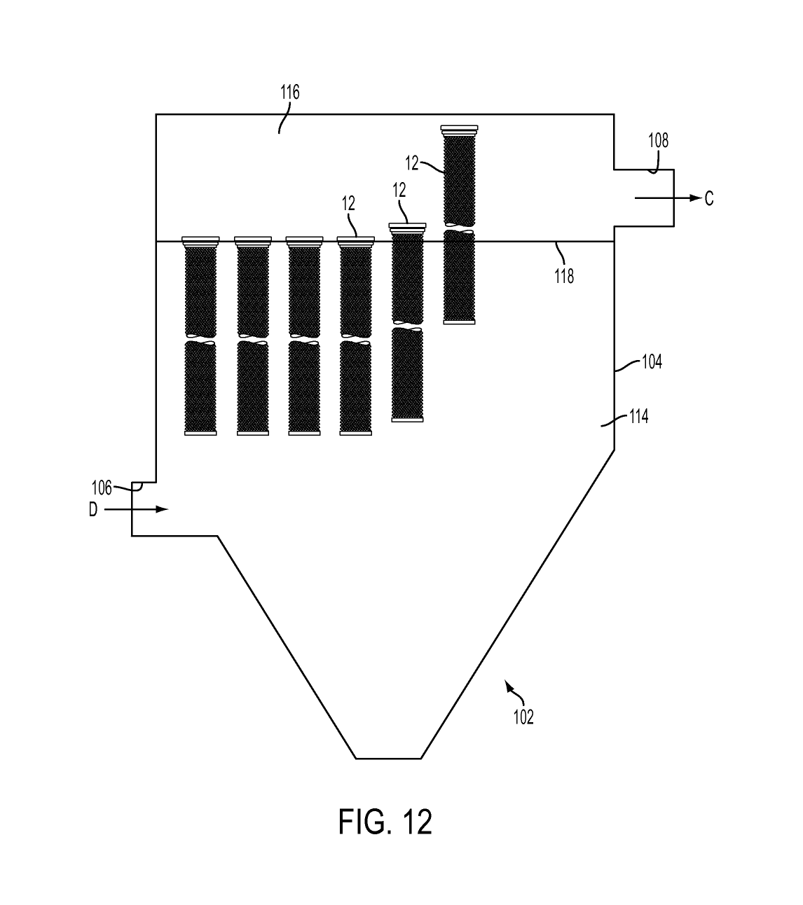

One example device 102 within which one or more filters 12 can be utilized in accordance with an aspect of the present invention is shown within FIG. 12. It is contemplated that one or more filters 12 can be used within various other devices. Turing to the example of FIG. 12, the device 102 can be considered to be a baghouse as bag-type filters could be utilized within the device. However, the filter(s) 12 in accordance with an aspect of the present invention can be utilized in lieu of the bag-type filters as is represented within FIG. 12.

The device (e.g., baghouse) 102 is defined by an enclosed housing 104. The housing 104 is made from a suitable material, such as sheet metal. Particulate laden fluid (e.g., gas such as exhaust gas) D flows into the device 102 at an inlet 106. The particulate laden gas D is filtered by a plurality of the filters 12 located within the device 102. Cleaned gas C exits through an outlet 108 of the device 102.

The device 102 is divided into a “dirty air” plenum 114 and a “clean air” plenum 116 by a sheet 118 made from a suitable material, such as sheet metal. The sheet 118 has at least a portion that is substantially planar. A plurality of openings extend through the planar portion of the sheet 118. A filter 12 is installed in each respective opening, and can optionally extend at least partially through the respective opening. With the example of FIG. 12, plural filters are in the process of being installed, with the last two shown not yet fully engaged into the sheet 118. Also, it is to be appreciated that although only six filters 12 are shown any number (e.g., a large plurality) could be utilized.

It is to be appreciated that the filter(s) 12 in accordance with an aspect of the present invention can be used within various devices. As such, the filter(s) 12 in accordance with an aspect of the present invention is not limited for use within the example device 102 (e.g., a baghouse) as shown within FIG. 12. As one example of yet another device within which the filter(s) 10 in accordance with an aspect of the present invention can be used is a gas turbine inlet filter house. However, even such use is not a limitation upon where the filter(s) 12 in accordance with an aspect of the present invention can be used.

The invention has been described with reference to various example embodiments. Obviously, modifications and alterations will occur to others upon a reading and understanding of this specification. It is intended to include all such modifications and alterations insofar as they come within the scope of the appended claims or the equivalents thereof.

What is claimed:

1. A method of making a rigid filter, the method including:
providing an elongate mandrel;
melting a polymer material;
forming the polymer material into a molten fiber;
moving the molten fiber to the mandrel;
accumulating successive layers of fibers about the mandrel and along the elongation of the mandrel to form a fiber accumulation, the fiber accumulation having pores extending between the fibers and having an exterior and a hollow interior; and
solidifying the fiber accumulation so that the fiber accumulation is rigid with the pores, the exterior and the hollow interior being present such that fluid can proceed between the exterior and the hollow interior through the pores and particulate is blocked by the fiber accumulation.

2. The method as set forth in claim 1, wherein the step of moving the molten fiber to the mandrel includes moving the molten fiber via a forced, heated air jet.

3. The method as set forth in claim 1, wherein the step of moving the molten fiber to the mandrel includes moving the molten fiber via two forced, heated air jets.

4. The method as set forth in claim 1, wherein the step of moving the molten fiber to the mandrel includes at least one of capillary action and venturi action.

5. The method as set forth in claim 1, including providing and entraining higher melting point staple fibers for movement within the molten fiber to the mandrel.

6. The method as set forth in claim 1, wherein the step of moving the molten fiber to the mandrel includes moving at least two fibers to the mandrel.

7. The method as set forth in claim 6, wherein the at least two fibers are different.

8. The method as set forth in claim 7, wherein the at least two fibers are of different material.

9. The method as set forth in claim 7, wherein the at least two fibers are of different thickness.

10. The method as set forth in claim 1, wherein material of the molten fiber includes at least one of polyethylene, ultra-high-molecular-weight polyethylene, polybutylene terephthalate, polytetrafluoroethylene, polyvinylidene difluoride, polyester, polypropylene, nylon and polyphenylene sulfide.

11. The method as set forth in claim 1, including removing the filter from the mandrel.

12. The method as set forth in claim 1, including providing the mandrel with bores through which a vacuum is applied to help draw the molten fibers onto the mandrel.

13. The method as set forth in claim 1, wherein the mandrel remains in place as part of the filter.

14. The method as set forth in claim 1, including heat treating the filter.

15. The method as set forth in claim 1, including chemically treating the filter.

16. The method as set forth in claim 1, including providing an oleophobic treatment to the filter.

17. The method as set forth in claim 1, wherein step of providing an elongate mandrel includes providing the mandrel as a cylinder such that the filter is a cylinder.

18. The method as set forth in claim 1, wherein step of providing an elongate mandrel includes providing the mandrel to have to have pleats such that the filter has pleats.

19. The filter as set forth in claim 11, including at least cutting or machining the filter.

20. The method as set forth in claim 1, including securing at least one of an end plate and a fitting to the filter.
